(19) United States
(12) Patent Application Publication
(10) Pub. No.: US 2008/0289915 A1
(43) Pub. Date: Nov. 27, 2008

(54) Braking structure of a lathe for allowing a workpiece to be gripped in position

(76) Inventors: Yung-Hsiang Lu, Chiayi City (TW); Chung-Lung Lin, Chiayi City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/802,270

(22) Filed: May 22, 2007

(51) Int. Cl. B23Q 11/00

(52) U.S. Cl. 188/74; 82/142

(57) ABSTRACT

A spindle braking mechanism of a lathe includes a pressing piece held in a head stock of the lathe, a brake pad positioned around and securely coupled to a spindle projecting from the head stock, a disc-brake disc interposed between the pressing piece and the brake pad, several elastic pushing elements positioned around the spindle and coupled to the head stock for biasing the pressing piece away from the disc, and two sensing and detecting devices coupled to the head stock for detecting motion of the pressing piece; a passage extends through the head stock, and a power source is used to provide pressure to the pressing piece through the passage; the disc will be pressed against the brake pad to stop the spindle when the power source is actuated; the elastic pushing elements will push the pressing piece away from the disc when the power source is turned off.

### BACKGROUND OF THE INVENTION

1. Field of the Invention

The present invention relates to a spindle braking structure of a lathe, more particularly one, which includes a brake pad positioned around and securely coupled to the spindle, a pressing piece in a head stock, a disc-brake disc between the pressing piece and the brake pad, and a power source; the power source being used for providing pressure to the pressing piece so as to make the disc tightly pressed against the brake pad to stop the spindle, thus allowing a workpiece to be gripped in a correct position with a chuck fitted on the spindle.

2. Brief Description of the Prior Art

In order for allowing a workpiece to be precision machined with a lathe, the workpiece first has to be gripped in the correct position with a chuck fitted on a spindle of the lathe, which will rotate relative to a tool in order for the workpiece to be shaped with the tool. However, it will be difficult to for the workpiece to be gripped in the correct position with the chuck if the spindle is free to rotate. Consequently, the accuracy of machining is reduced.

Shown in FIG. 5 is a currently existing spindle structure of a lathe, which includes a spindle 5, an exposed disc-brake disc 51 positioned around and securely joined to the spindle 5, a pair of sandwiching pieces 52 on two sides of the disc-brake disc 51, and a power source 53 to drive the sandwiching pieces 52; the sandwiching pieces 52 have O-shaped rings 55 tightly positioned around them. Therefore, the sandwiching pieces 52 can be moved and tightly pressed against the disc-brake disc 51 to stop and immobilize the spindle 5 by means of operating the power source 53, thus allowing a workpiece to be easily gripped in the correct position with a chuck 54 on the spindle 5.

The above lathe spindle structure has the following drawbacks:

The disc-brake disc 51 is exposed, and extends a relatively long distance to the sandwiching pieces 52, being larger than the chuck 54. Therefore, the disc-brake disc 51 occupies too much space, and would interfere with machining of certain workpieces.

Bits and small pieces of metal would be produced to cause reduction to power of the brake structure owing to the disc-brake disc 51 rubbing against the sandwiching pieces 52. The disc-brake disc 51 is exposed therefore dust and small pieces will fall onto the disc-brake disc, which are difficult to clean away.

The spindle structure has no means to find out whether the power source 53 has functioned properly and whether the sandwiching pieces have been tightly pressed against the disc-brake disc. Consequently, the spindle can be still free to rotate, and a workpiece can't be gripped in a correct position with the chuck. Furthermore, it is possible for the O-shaped rings 55 to become slightly loose to reduce smoothness of motion of the sandwiching pieces 52, and accuracy of machining.

### SUMMARY OF THE INVENTION

It is a main object of the present invention to provide an improvement on a spindle braking structure of a lathe to overcome the above problems. A braking structure according to an embodiment of the present invention includes a pressing piece held in a head stock, a power source, a brake pad positioned around and securely coupled to a spindle projecting from the head stock, a disc-brake disc interposed between the pressing piece and the brake pad, several elastic pushing elements positioned around the spindle and coupled to the head stock, and two sensing and detecting devices coupled to the head stock for detecting motion of the pressing piece so as to help ensure that the spindle is stopped/free to move. A passage extends through the head stock, and the power source is used to provide pressure to the pressing piece through the passage. Therefore, when the power source is actuated, the disc will be pressed against the brake pad to stop the spindle. And, the elastic pushing elements will push the pressing piece away from the disc when the power source is turned off, thus relieving the pressure exerted on the disc by the pressing piece.

### BRIEF DESCRIPTION OF THE DRAWINGS

The present invention will be better understood by referring to the accompanying drawings, wherein:

FIG. 1 is a sectional view of the present invention,

FIG. 2 is a sectional view of the braking device of the present invention,

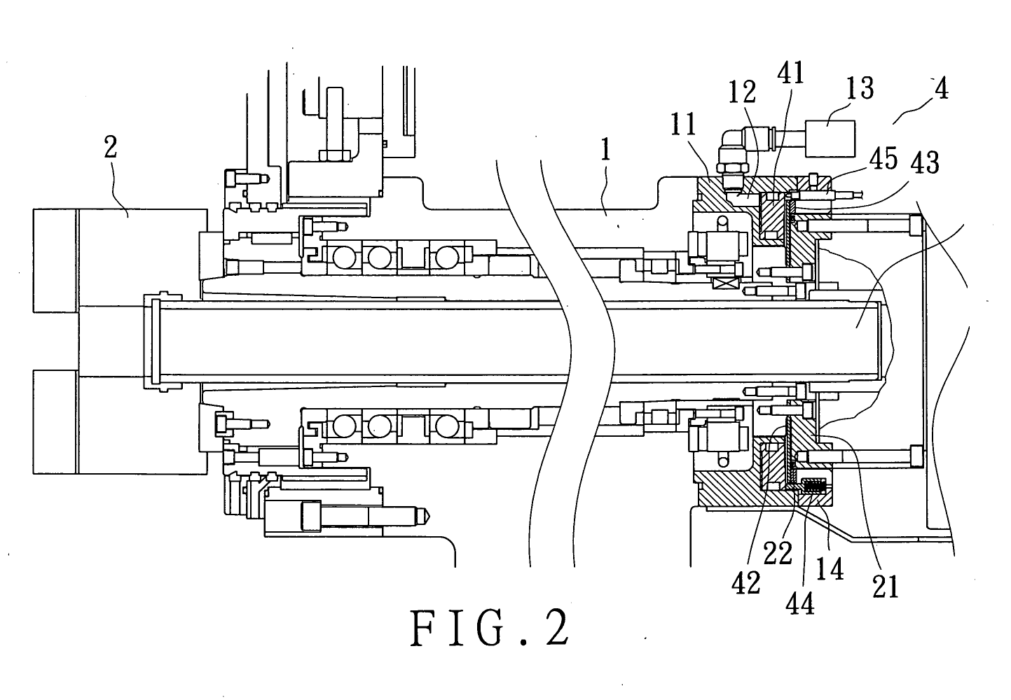

FIG. 3 is a partial view of the present invention,

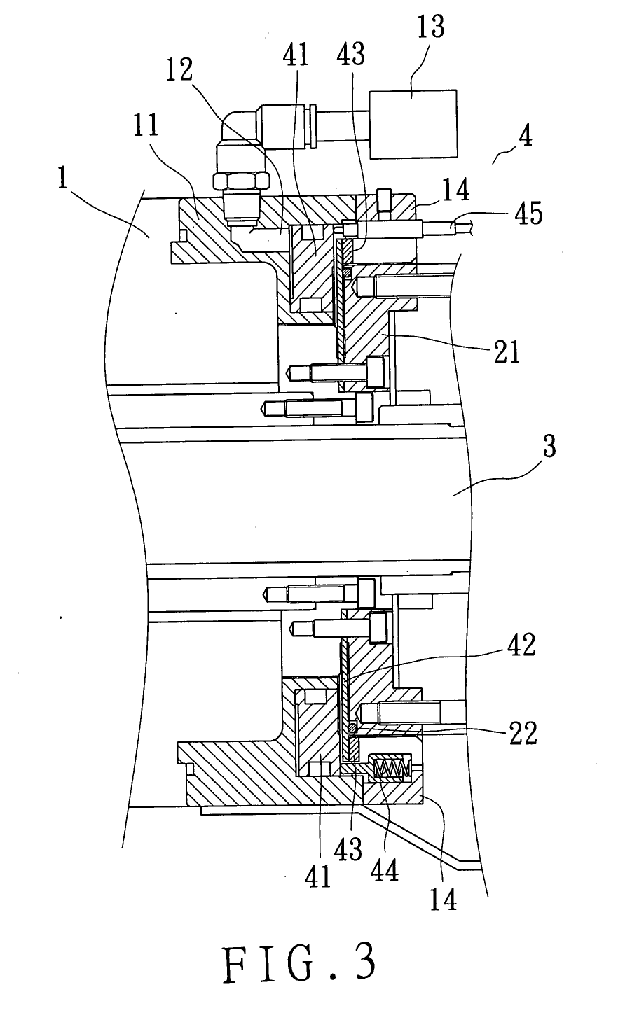

FIG. 4 is a partial view of the present invention, taken when the braking device is functioning, and

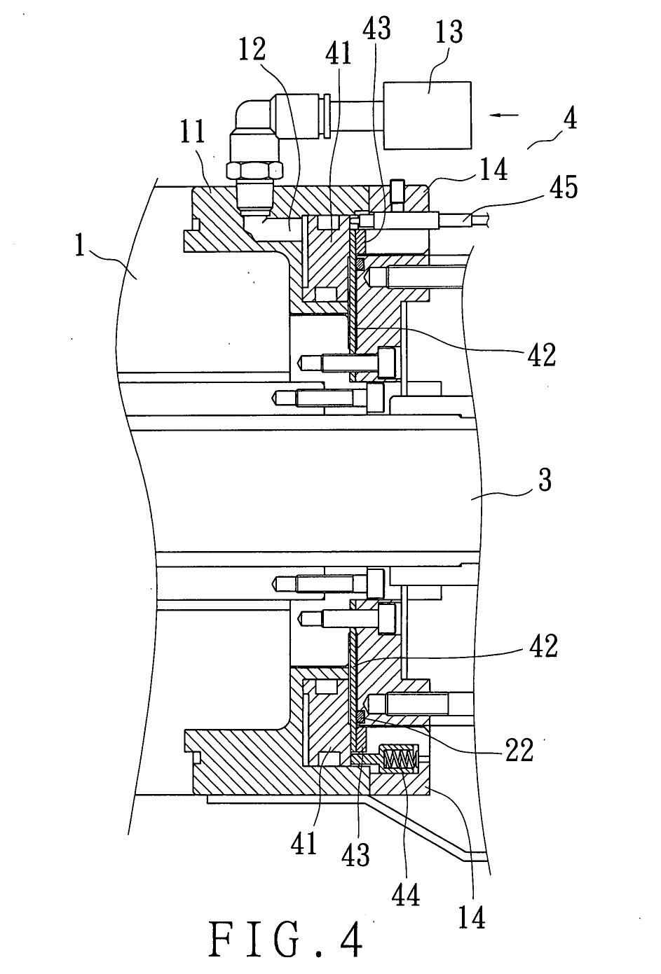

FIG. 5 is a structural view of the prior art.

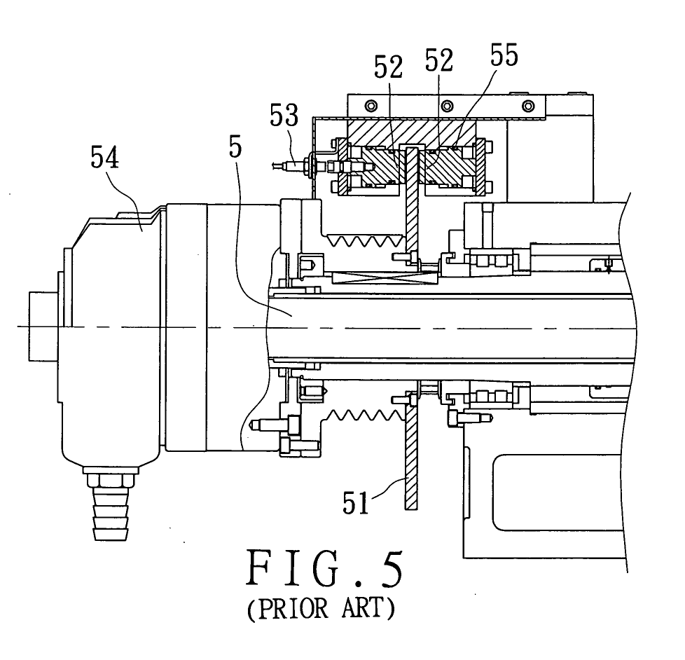

### DETAILED DESCRIPTION OF THE PREFERRED EMBODIMENTS

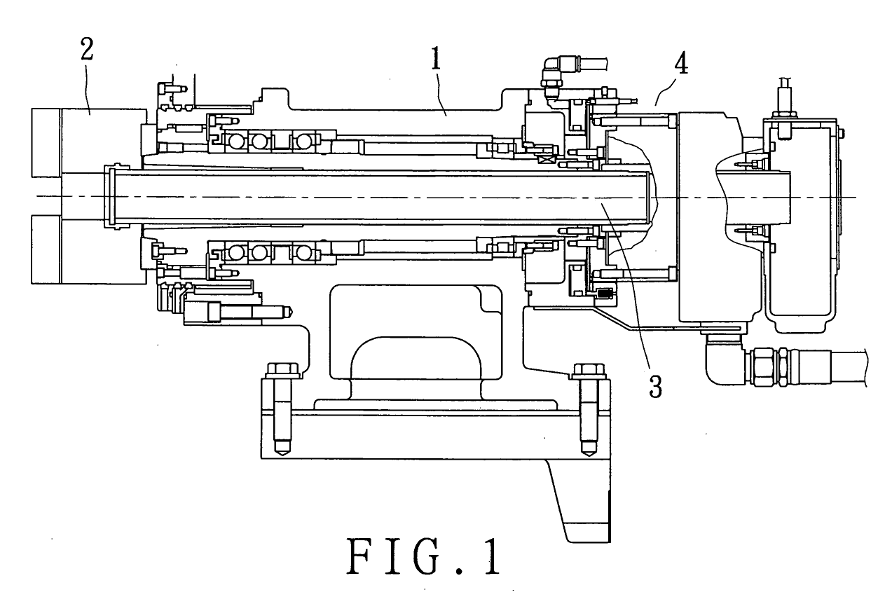

Shown in FIG. 1 is a preferred embodiment of a braking structure of a lathe in the present invention, which includes:

(a) several passages 12 extending through a head stock 11 disposed on a bed 1 of the lathe, which further includes a spindle 3 projecting out from the head stock 11, and a chuck 2 joined to the spindle 3;

(b) a power source 13 connected to the head stock 11 so as to provide pressure through the passages 12, which extend in the head stock 11 of the lathe; the power source 13 can be an oil hydraulic power device or an air-pressure power device;

(c) an annular supporting member 14 fixedly joined to an outer side of the head stock 11;

(d) a holding member 21 positioned next to the head stock 11 and securely joined to the spindle 3; the holding member 21 has a ringed pad 22 secured thereon; and

(e) a braking mechanism 4 joined to the spindle 3 of the lathe; the braking mechanism 4 includes:

a pressing piece 41, which is positioned in the head stock 11 so as to be faced with and adjacent to outlet ends of the passages 12 extending through the head stock 11;

a brake pad 43 secured on an annular edge of the holding member 21 secured on the spindle 3;

a disc-brake disc 42, the disc-brake disc 42 is positioned around the spindle 3, and interposed between the pressing piece 41 and the holding member 21 so as to be in touch with the ringed pad 22 secured on the holding member 21; thus, the pressing piece 41 are adjacent to one side of the disc-brake disc 42, and the brake pad 43 is adjacent to the other side of disc-brake disc 42;

at least one composite elastic pushing elements 44 fitted on a first portion of the annular supporting member 14 so as to be near and point at the pressing piece 41; there are preferably six composite elastic pushing elements 44, which are spaced apart around a center of the annular supporting member 14; and

two sensing and detecting devices 45, the sensing and detecting devices 45 are fitted on said first portion of the annular supporting member 14 so as to be near and point at the pressing piece 41.

Therefore, in order for allowing a workpiece to be griped in a correct position by the chuck 2, first the power source 13 is actuated to provide pressure, which will go to the pressing piece 41 through the passages 12 so as to make the pressing piece 41 push the disc-brake disc 42 towards the brake pad 43 secured on the holding member 21 securely joined to the spindle 3; thus, the pressing piece 41 is tightly pressed against the disc-brake disc 42, and the disc-brake disc 42 is tightly pressed against the brake pad 43. Consequently, the spindle 3 is stopped, and prevented from rotating relative to the head stock 11 by means of the braking structure, and a workpiece can be gripped with the chuck 2, and adjusted to the correct position.

In addition, when the pressing piece 41 is pressed against the disc-brake disc 42, it will compress the composite elastic pushing elements 44 fitted on the annular supporting member 14 secured on the outer side of the head stock 11; thus, as soon as the power source 13 is turned off, the composite elastic pushing elements 44 will return to their original shape, and push the pressing piece 41 so as to relieve the pressure exerted on the disc-brake disc 42 by the pressing piece 41, and the spindle 3 is allowed to rotate.

Furthermore, the sensing and detecting devices 45 will detect the motion of the pressing piece 41 when the power source 13 is actuated; thus, it can be found out whether the disc-brake disc 42 has been effectively pressed against the brake pad so as to stop the spindle 3. And, the sensing and detecting devices 45 will detect the motion of the pressing piece 41 after the power source 13 is turned off; thus, it can be found out whether the pressing piece 41 has been pushed away from the disc-brake disc 42 so as to on loner press the disc-brake disc 42 against the brake pad 43. Consequently, the sensing and detecting devices 45 can help to ensure that the spindle 3 is stopped/free to rotate when the power source 13 is actuated/turned off.

From the above description, it can be seen that the braking structure of the present invention has the following advantages over the prior art:

1. The braking structure is provided within the bed of the lathe, and pressure exerted by the power source goes to the pressing piece and the disc-brake disc through the passages in the head stock so as to press the disc-brake disc tightly against the brake pad. Therefore, the braking structure can stop and immobilize the spindle effectively and stably.

2. The braking structure includes the ringed pad, which is secured on the holding member, and in touch with the disc-brake disc. Therefore, power, dust, bits and small pieces of things are prevented from falling onto an inner portion of the disc-brake disc and the spindle to interfere with rotation of the spindle.

3. The braking structure includes the composite elastic pushing elements, which will push the pressing piece so as to relieve the pressure exerted on the disc-brake disc by the pressing piece as soon as the power source is turned off, thus allowing the spindle to regain the freedom to rotate.

4. The braking structure includes the sensing and detecting devices to find out whether the disc-brake disc has been effectively pressed against the brake pad so as to stop the spindle. Therefore, the sensing and detecting devices can help to ensure stoppage of the spindle.

5. The braking structure includes the sensing and detecting devices to find out whether the pressure has been relieved, which is exerted on the disc-brake disc by the pressing piece. Therefore, the sensing and detecting devices can help to ensure that the spindle is free to rotate again.

What is claimed is:

1. A braking structure of a lathe for allowing a workpiece to be gripped in position, comprising
a braking mechanism coupled to a spindle of a lathe, which projects from a head stock on a bed of the lathe, and to which a chuck is joined; the spindle having a holding member securely joined thereto, which is arranged next to the head stock; the holding member having a ringed pad positioned thereon; the head stock having an annular supporting member fixedly joined thereto;
the braking mechanism including:
(a) at least one pressing piece held in the head stock; the head stock having a plurality of passages extending through it to face one side of said at least one pressing piece;
(b) a power source connected to the head stock so as to provide pressure to said at least one pressing piece through the passages extending through the head stock;
(c) a brake pad secured on an annular edge of the holding member secured on the spindle;
(d) a brake disc, the brake disc being interposed between said at least one pressing piece and the holding member; the brake disc being faced with the ringed pad secured on the holding member;
(e) a plurality of composite elastic pushing elements, the composite elastic pushing elements being fitted on the annular supporting member so as to face said at least one pressing piece; and
(f) two sensing and detecting devices fitted on the annular supporting member so as to face said at least one pressing piece.

2. The braking structure of a lathe for allowing a workpiece to be gripped in position, as recited in claim 1, wherein the power source is an oil hydraulic power device.

3. The braking structure of a lathe for allowing a workpiece to be gripped in position, as recited in claim 1, wherein the power source is an air-pressure power device.

4. The braking structure of a lathe for allowing a workpiece to be gripped in position, as recited in claim 1, wherein there are more than one said composite elastic pushing elements.

5. The braking structure of a lathe for allowing a workpiece to be gripped in position, as recited in claim 1, wherein the sensing and detecting devices are used to find out a distance said at least one pressing piece has moved so as to push the brake disc, and used to find out a distance said at least one pressing piece has moved away from the brake disc as well.
